(19) United States
(12) Patent Application Publication
(10) Pub. No.: US 2007/0016698 A1
(43) Pub. Date: Jan. 18, 2007

(54) Memory channel response scheduling

(76) Inventor: Pete D. Vogt, Boulder, CO (US)

Correspondence Address: MARGER JOHNSON & MCCOLLOM, P.C., 210 SW MORRISON STREET, SUITE 400, PORTLAND, OR, 97204, US

(21) Appl. No.: 11/165,582

(22) Filed: Jun. 22, 2005

(51) Int. Cl. G06F 3/00

(52) U.S. Cl. 710/1

(57) ABSTRACT

A memory agent schedules local and pass-through responses according to an identifier for each response. A response file may be large enough to store responses for a maximum number of requests that may be outstanding on a memory channel. A request file may be large enough to store requests for a maximum number of requests that may be outstanding on the memory channel. The identifier for each request and/or response may be received on the same channel link as the request and/or response. Other embodiments are described and claimed.

### BACKGROUND

FIG. 1 illustrates a prior art memory system having a memory controller 10 and memory modules 12 connected on a channel through data links 16. The memory controller sends requests to the individual memory modules over the data links. If the module closest to the memory controller receives a request intended for another module, it forwards the request to the next module. The request is repeatedly forwarded until it reaches the intended module. Each memory module services its own requests, generally by accessing memory devices such as read only memory (ROM), dynamic random access memory (DRAM), flash memory, etc. located on the module, and generates a corresponding response which is transmitted back to the controller over the channel.

Each memory module includes a buffer 14 that temporarily stores data as it is passed between the modules and controller. The channel also includes dedicated flow control handshake signals 18 that are used to prevent the buffers from overflowing if the controller or one of the modules sends more data than the buffer on another module can accommodate.

FIG. 2 illustrates another prior art memory system which includes a memory controller 20 and one or more memory modules 22 that communicate through a channel made up of unidirectional links. The channel has an outbound path that includes one or more outbound links 24, and an inbound path that includes one or more inbound links 26. Each module is capable of redriving signals from link to link on the outbound path and from link to link on the inbound path. Each module includes one or more memory devices 28 arranged to transfer data to and/or from one or more of the paths.

The system of FIG. 2 utilizes a deterministic protocol in which requests are sent to the modules over the outbound path, and responses are returned to the controller during predetermined time slots in a return data frame on the inbound path. The memory controller schedules all of the communication over the channel, and each module may only send its responses to the controller during its allocated time slots. Because all communication occurs at predetermined times, no handshaking is necessary to prevent overflow of any buffers that may be located on the modules.

### BRIEF DESCRIPTION OF THE DRAWINGS

FIG. 1 illustrates a prior art memory system.

FIG. 2 illustrates another prior art memory system.

FIG. 3 illustrates an embodiment of a memory agent according to the inventive principles of this patent disclosure.

FIG. 4 illustrates embodiments of memory components according to the inventive principles of this patent disclosure.

FIG. 5 illustrates another embodiment of a memory agent according to the inventive principles of this patent disclosure.

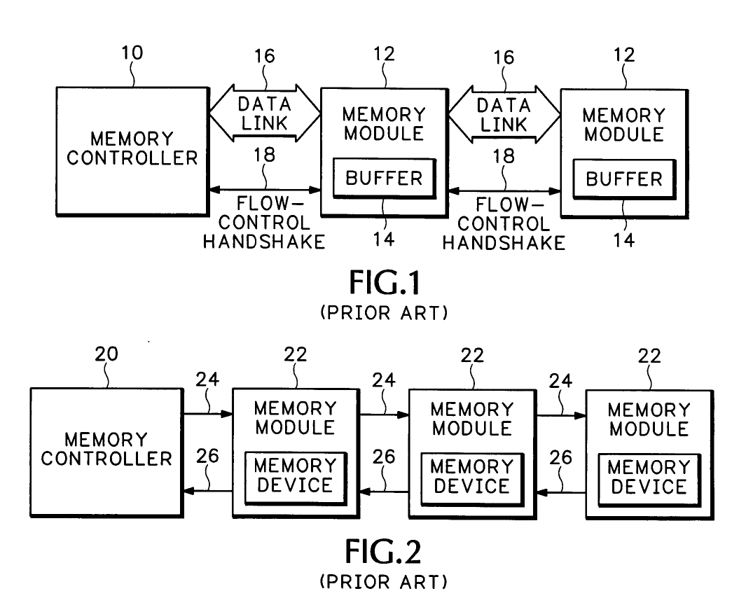

### DETAILED DESCRIPTION

This patent disclosure encompasses multiple inventive principles that have independent utility. In some cases, additional benefits may be realized when some of the principles are utilized in various combinations with one another, thus giving rise to additional inventions. These principles may be realized in countless embodiments. Although some specific details are shown for purposes of illustrating the inventive principles, many other arrangements may be devised in accordance with the inventive principles of this patent disclosure. Thus, the inventive principles are not limited to the specific details disclosed herein.

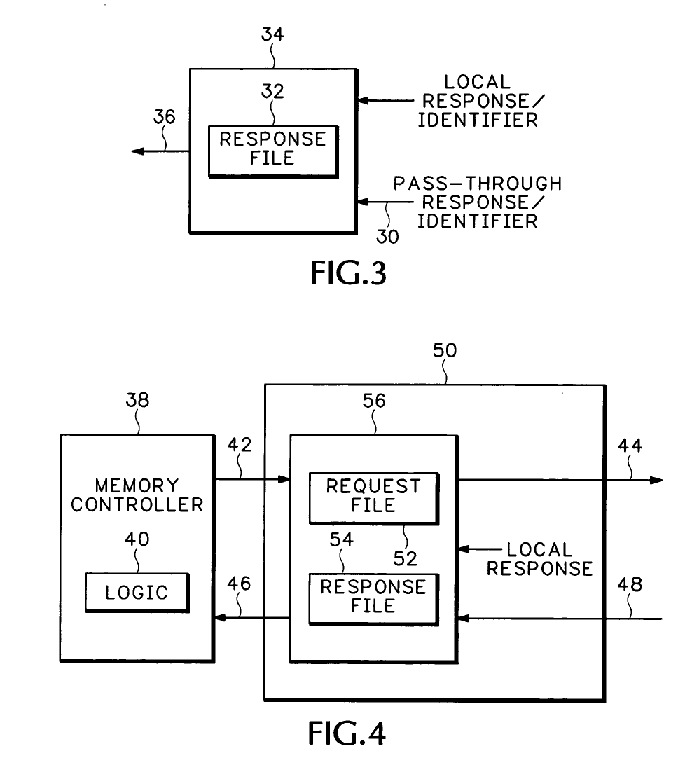

FIG. 3 illustrates an embodiment of a memory agent according to the inventive principles of this patent disclosure. The embodiment of FIG. 3 may be employed in a memory system that uses a transaction-based protocol in which the individual memory agents schedule their own responses to requests from a memory controller. The embodiment of FIG. 3 may receive pass-through responses from other memory agents over link 30. A response file 32 stores pass-through responses, was well as locally generated responses. Each response has an identifier. Logic 34 schedules transmission of responses from the response file 32 to another agent or memory controller over link 36. The identifier for each response may include priority information that the scheduling logic uses to re-order the sequence in which responses are transmitted. The identifier for each pass-through response may be received over the same link as the response itself, for example, it maybe embedded in the response.

FIG. 4 illustrates an embodiment of a memory system including embodiments of a controller and one or more memory agents according to the inventive principles of this patent disclosure. A memory controller 38 includes logic 40 to transmit requests having identifiers over a memory channel. In this example, the channel includes outbound links 42,44 and inbound links 46,48. Memory agent 50 includes a response file 54 to store pass-through responses received over link 40, as well as locally generated responses. A request file 52 stores requests received on link 42. The requests may be local requests intended for memory resources located at agent 50, or they may be pass-through requests that are forwarded to another agent over link 44.

Each request and its resulting response have an identifier. The identifier for each request and pass-through response may be received over the same link as the request or response itself; for example, it maybe embedded in the request or response. Logic 56 schedules the transmission of responses from the response file 54 to another agent or memory controller over link 46 according to the identification for each response in the response file. It may also consider the identifiers for requests in the request file 52 when scheduling the responses.

The identifier for each request and response may include priority information that the scheduling logic uses to re-order the sequence in which responses are transmitted. The identifiers may also be unique. For example, if the controller logic 40 has a maximum number of outstanding requests, it may assign each request a unique number up to the maximum number of requests, and the request and response files in the memory agent may be made large enough to store requests and responses for the maximum number of requests. As another example, the identifiers may be implemented as time stamps with earlier requests generally given higher priority than later requests. The requests and responses may be stored in their respective files in the relative order of their identifiers.

The memory components of FIGS. 3 and 4 may be implemented in any suitable physical arrangement. For example, either of the memory agents 34 and 50 may be fabricated monolithically as a integrated circuit (IC) which may then be mounted, for example, on a printed circuit board (PC board). A memory agent may also include a memory interface for communicating with memory devices such as DRAM chips. A memory agent according to the inventive principles of this patent disclosure may be implemented as a memory hub, which may include much of the same functionality as a memory buffer, but may also include additional functionality such as a controller for memory devices, e.g., a DRAM controller.

A memory module according to the inventive principles of this patent disclosure may include a memory buffer fabricated as an IC chip and mounted on a PC board along with memory devices also mounted on the board and communicating with the buffer through the memory interface. The module may be connected to a computer mother board through, for example, a card-edge connector. A memory controller according to the inventive principles of this patent disclosure may be fabricated as part of a processor or processor chipset and mounted on the mother board to form a memory channel with the buffered module. Alternatively, the memory controller, memory agent and memory devices may be fabricated on a single PC board. Other arrangements are possible in accordance with the inventive principles of this patent disclosure.

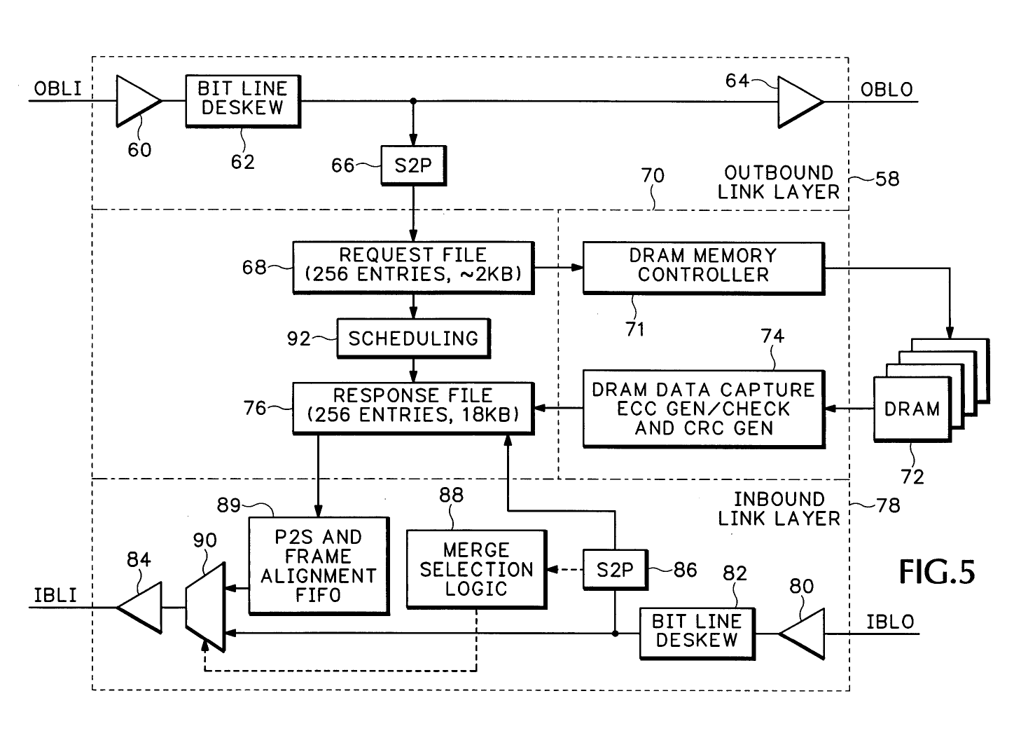

FIG. 5 illustrates another embodiment of a memory agent according to the inventive principles of this patent disclosure. The embodiment of FIG. 5 implements a memory hub for use in a memory channel having dual data paths with unidirectional links between components. Outbound link layer 58 includes receivers 60 receive signals on signal lanes OBLI, lane deskew circuitry 62, and redrive circuitry 64 to resend outbound requests to other hubs on signal lanes OBLO. A serial-to-parallel (S2P) circuit 66 converts requests to parallel format for request file 68 which is large enough to handle requests for the maximum number of outstanding requests that may be implemented by a memory controller on the memory channel. A memory interface 70 interfaces the hub to memory devices, which in this example are DRAM chips, 72. The interface includes a DRAM memory controller 71 to abstract the control of the memory devices from the controller. Alternatively, the memory controller may be omitted, in which case the memory controller could generate DRAM commands may be forwarded directly the memory devices. The memory interface also includes circuitry 74 for data capture, error detection and correction, etc.

Responses generated locally are stored in response file 76, which is also large enough to store responses for the maximum of outstanding requests that may be implemented by the memory controller. The response file 76 also stores pass-through responses that may be received from more outer hubs. An inbound link layer 78 includes receivers 80 to receive signals on signal lanes IBLI, lane deskew circuitry 82, and redrive circuitry 84 to resend inbound responses to other hubs or a memory controller on signal lanes IBLO. A serial-to-parallel (S2P) circuit 86 converts responses to parallel format for storage in the response file. The inbound link layer further includes merge selection logic 88 to merge local responses into the inbound dataflow while trying to maintain bubble-free data flow to the memory controller. Parallel-to-serial (P2S) and frame alignment FIFO circuitry 89, along with multiplexer 90 complete the connection from response file to inbound data link.

Scheduling logic 92 snoops the request and response files to schedule the order in which the local and pass-through responses are transmitted on the inbound link.

In one embodiment, the memory controller assigns a unique identifier to each request as an incrementing value used as a timestamp to represent the relative priority of the request.

Requests with lower numbers (and therefore, higher priority) are generally given priority over later requests with higher numbers. The controller may thus assign identifiers in a manner so that responses to high-priority requests are forwarded to the controller before responses to lower-priority requests, while still avoiding starvation of responses from the outermost hubs.

When a hub receives a request, it decodes the request, accesses local memory resources to service the request, and generates an inbound response. A hub at the outermost end of the channel has no conflicts with responses from other hubs, so it may send its response as soon as it is available. Hubs closer to the memory controller, however, may not know when an outer hub may begin transmitting a response on the inbound link. A hub may therefore store inbound responses from other hubs in its response file. By making the response file large enough to store responses for all outstanding requests, it may be possible to assure that no collisions occur on the inbound path, and no responses are lost. This may be possible even without any dedicated handshake signaling or logic. If each request/response is assigned a unique identifier, and the response file includes a space dedicated to the response for each identifier, there may always be room to store any response, whether locally generated or pass-through.

In an example embodiment, the responses buffered by the memory hub are stored in the response file in the relative order of their identifiers. Before a hub sends its own locally generated response, the scheduling logic checks the response file to see if any higher priority responses are available. If there is, the hub may store its own response in the response file, and then send the higher priority response before its own. As responses are transmitted on the inbound link, more responses may be received from outer hubs. Some of these responses may have higher priority than response already in the response file, in which case, they may be re-ordered ahead of previously received responses.

While the response scheduling is operating, the local memory hub continues to service its own requests. If a local request having a higher priority that anything in the request file is completed, it may be sent immediately on the inbound link. I the local request completion has a lower priority than a response in the response file, the higher priority response is sent to the controller, and the lower priority local response is stored in its designated location in the response file for delivery at a later time.

The scheduling logic may also consider the status of requests still pending in the request file when determining how to re-order the flow of responses.

The embodiments described above may be modified in arrangement and detail without departing from the inventive principles. For example, some embodiments of memory agents have been illustrated with interfaces to four links for use in a memory channel having dual data paths with unidirectional (simplex) links between components, but the inventive principles may also be applied to memory agents arranged in a ring topology. As another example, logic may be implemented as either circuitry (hardware) or as software without departing from the inventive principles. Accordingly, such changes and modifications are considered to fall within the scope of the following claims.

1. A memory agent comprising:
a response file to store local and pass-through responses; and
logic to schedule transmission of the responses according to an identifier for each response.

2. The memory agent of claim 1 where the identifiers for the pass-through responses are received on the same link as the pass-through responses.

3. The memory agent of claim 1 where the identifiers comprise priority information.

4. The memory agent of claim 3 where the logic to schedule transmission comprises logic to reorder transmissions based on the priority of each response.

5. The memory agent of claim 1 where the responses are stored in the response file in the relative order of their identifiers.

6. The memory agent of claim 1 further comprising a request file to store requests having identifiers.

7. The memory agent of claim 6 where the identifiers for each request are received on the same link as requests.

8. The memory agent of claim 6 where the request file stores local requests and pass-through requests.

9. The memory agent of claim 6 where the requests are stored in the request file in the relative order of their identifiers.

10. The memory agent of claim 1 where:
the pass-through responses are received on a first link; and
the local and pass-through responses are transmitted on a second link.

11. The memory agent of claim 7 where:
the pass-through responses are received on a first link;
the local and pass-through responses are transmitted on a second link; and
the requests are received on a third link.

12. The memory agent of claim 9 where:
the pass-through responses are received on a first link;
the local and pass-through responses are transmitted on a second link;
the local and pass-through requests are received on a third link; and
the pass-through requests are transmitted on a fourth link.

13. A memory system comprising:
a memory controller comprising logic to transmit requests having priorities over a channel; and
a memory agent coupled to the channel and comprising:
a response file to store local responses and pass-through responses; and
logic to schedule transmission of the responses to the memory controller according to the priority of each response.

14. The system of claim 13 where:
the memory controller logic has a maximum number of outstanding requests; and
the response file is large enough to store responses for the maximum number of requests.

15. The system of claim 13 where the memory agent further comprises a request file to store requests having priorities.

16. The system of claim 15 where:
the memory controller logic has a maximum number of outstanding requests; and
the request file is large enough to store requests for the maximum number of requests.

17. The system of claim 15 where the memory agent logic comprises logic to schedule transmission of the responses according to the priority of each request and response.

18. The system of claim 13 where the priorities comprise time stamps.

19. The system of claim 13 where the memory agent further comprises a memory interface.

20. The system of claim 19 where the response file, the logic, and the memory interface are fabricated on an integrated circuit.

21. The system of claim 20 where the memory agent further comprises memory devices coupled to the memory interface.

22. The system of claim 21 where the integrated circuit and the memory devices are mounted on a printed circuit board.

23. A method comprising:
storing local and pass-though responses in a response file at a memory agent; and
transmitting the responses according to an identifier for each response.

24. The method of claim 23 further comprising receiving the identifiers for the pass-through responses on the same link as the pass-through responses.

25. The method of claim 23 further comprising storing local and pass-through requests having identifiers at the memory agent.

26. The method of claim 25 further comprising transmitting the responses according to an identifier for each request and response.

27. A method comprising:
transmitting requests having priorities from a memory controller to a memory agent over a channel;
storing local and pass-though responses in a response file at the memory agent; and
transmitting the responses from the memory agent to the memory controller according to the priority of each response.

28. The method of claim 27 further comprising storing local and pass-through requests having priorities at the memory agent.

29. The method of claim 28 further comprising transmitting the responses from the memory agent to the memory controller according to the priority of each request and response.
